(19) United States
(12) Patent Application Publication
(10) Pub. No.: US 2024/0411602 A1
(43) Pub. Date: Dec. 12, 2024

(54) COMPUTER AND PROGRAM

(71) Applicant: Nippon Telegraph and Telephone Corporation, Tokyo (JP)

(72) Inventors: Yuki Arikawa, Tokyo (JP); Kenji Tanaka, Tokyo (JP); Tsuyoshi Ito, Tokyo (JP); Naoki Miura, Tokyo (JP); Takeshi Sakamoto, Tokyo (JP)

(21) Appl. No.: 18/700,828

(22) PCT Filed: Dec. 8, 2021
(86) PCT No.: PCT/JP2021/045074

§ 371 Date: Apr. 12, 2024

(51) Int. Cl. G06F 9/50

(52) U.S. Cl. CPC G06F 9/5027

(57) ABSTRACT

A computing machine is a computing machine capable of adding or deleting a computational resource R for processing input data input from outside, and includes: a state information acquisition unit that acquires state information indicating a state of the computing machine; and a performance estimation unit that estimates, on the basis of the state indicated by the state information, a change in processing performance of the computing machine when at least one of dynamic addition or deletion of a computational resource or an increase in data amount of the input data or output data occurs.

### CROSS-REFERENCE TO RELATED APPLICATIONS

This application is a national phase entry of PCT Application No. PCT/JP2021/045074, filed on Dec. 8, 2021, which application is hereby incorporated herein by reference.

### TECHNICAL FIELD

The present invention relates to a computing machine and a program.

### BACKGROUND

Technological innovation has progressed in many fields such as in machine learning, artificial intelligence (AI), and the Internet of Things (IoT), and the sophistication of services and the provision of added values thereto is being actively performed by utilizing various types of data. In such processing, it is necessary to perform a large amount of calculation, and an information processing infrastructure therefor is essential.

For example, Non Patent Literature 1 points out that while attempts have been made to update existing information processing infrastructures, modern computers have not been able to catch up with rapidly increasing data. Non Patent Literature 1 also points out that “post-Moore technology” that surpasses Moore's Law needs to be established for further evolution in the future.

As the post-Moore technology, for example, Non Patent Literature 2 discloses a technology called flow-centric computing. The flow-centric computing has introduced a new concept of moving data to a location where a calculation function (computational resource) exists and performing processing, rather than the conventional idea of computing in which processing is performed at a location where data exists.

### CITATION LIST

### Non Patent Literature

Non Patent Literature 1: “NTT Technology Report for Smart World 2020”, Nippon Telegraph and Telephone Corporation, 2020, https://www.rd.ntt/_assets/pdf/techreport/NTT_TRFSW_2020_EN_W.pdf
Non Patent Literature 2: R. Takano and T. Kudoh, “Flow-centric computing leveraged by photonic circuit switching for the post-moore era”, Tenth IEEE/ACM International Symposium on Networks-on-Chip (NOCS), Nara, 2016, pp. 1-3.

### SUMMARY

### Technical Problem

In order to achieve flow-centric computing as described above, it is necessary to appropriately manage which hardware to use to constitute a computational resource. For example, constituting a computational resource using hardware of a computing machine having a high load without appropriate management may result in a delay in processing by the computational resource. Using hardware of a computing machine having a low load without appropriate management to configure a plurality of computational resources having the same function may result in unnecessarily large power consumption of the computing machine.

It is an object of embodiments of the present invention to appropriately manage a hardware configuration of a plurality of computational resources that performs at least a part of a service for processing of processing target data.

### Solution to Problem

In order to solve the above problems, embodiments of the present invention provide a computing machine capable of adding or deleting a computational resource for processing input data input from outside, the computing machine including: a state information acquisition unit that acquires state information indicating a state of the computing machine; and a performance estimation unit that estimates, on the basis of the state indicated by the state information, a change in processing performance of the computing machine when at least one of dynamic addition or deletion of a computational resource or an increase in data amount of the input data or output data occurs.

In order to solve the above problems, embodiments of the present invention provide a program for causing a computer capable of adding or deleting a computational resource for processing input data input from outside to execute: a state information acquisition step of acquiring state information indicating a state of a computing machine; and a performance estimation step of estimating, on the basis of the state indicated by the state information, a change in processing performance of the computing machine when at least one of dynamic addition or deletion of a computational resource or an increase in data amount of the input data or output data occurs.

### Advantageous Effects of Embodiments of Invention

According to embodiments of the present invention, it is possible to appropriately manage a hardware configuration of a plurality of computational resources that performs at least a part of a service for processing of processing target data.

### BRIEF DESCRIPTION OF THE DRAWINGS

FIG. 1 is a hardware configuration diagram of a computing machine according to a first embodiment of the present invention.

FIG. 2 is a block diagram illustrating a configuration of the computing machine in FIG. 1.

FIG. 3 is an operation flowchart of the computing machine in FIG. 1.

FIG. 4 is an operation flowchart of a quality management unit in FIG. 1.

FIG. 5 is a block diagram illustrating a configuration of a computing machine according to a second embodiment.

FIG. 6 is a block diagram illustrating a configuration of a computing machine according to a third embodiment.

FIG. 7 is an operation flowchart of a quality management unit in FIG. 6.

### DETAILED DESCRIPTION OF ILLUSTRATIVE EMBODIMENTS

The following is a description of embodiments of the present invention, with reference to the drawings. In the following description, elements having the same function, elements having different functions but corresponding to each other, and the like will be appropriately denoted by the same reference numerals. In a case of a plurality of elements having the same function or corresponding to each other, only some of the elements may be denoted by the reference numeral in the drawings.

### First Embodiment

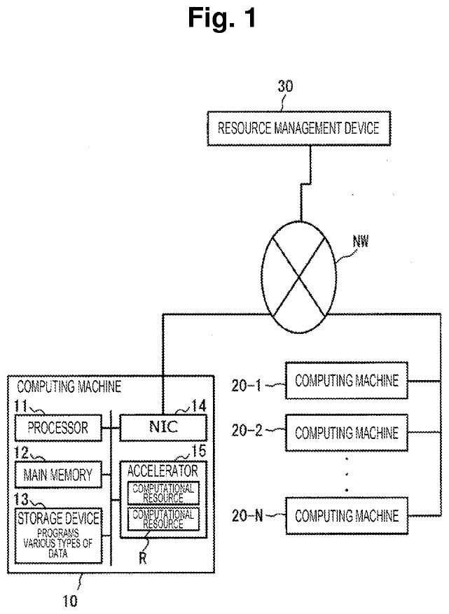

A computing machine 10 according to the present embodiment is illustrated in FIG. 1. The computing machine 10 is used together with other computing machines 20-1 to 20-N(N is a natural number). The computing machine 10 and the other computing machines 20-1 to 20-N are provided so a to be able to communicate with a resource management device 30 via a network NW such as the Internet or a local area network (LAN). The computing machine 10 and the other computing machines 20-1 to 20-N are also provided so as to be able to communicate with each other via the network NW. The computing machines 10 and 20-1 to 20-N are constituted by various computers such as a personal computer, a smartphone, and a tablet. The resource management device 30 is constituted by a server computer or the like.

The resource management device 30 instructs the computing machines 10 and 20-1 to 20-N to add or delete a computational resource R. In this manner, the resource management device 30 manages a plurality of computational resources R that share and process a predetermined service. Here, a plurality of types of services is prepared, and sets of computational resources R in different combinations, one set for each service, are used. The services include image processing. For example, a plurality of computational resources R that perform one service are connected via a virtual network configured in the network NW or the like, and process processing target data in series and/or in parallel. For example, as one service, image data as processing target data is binarized by parallel processing by two computational resources R of the computing machine 10, the binarized image data is then subjected to image recognition processing by a computational resource R of the computing machine 20-1, and a processing result is returned to a provider (not illustrated) of the image data. The provider is, for example, a client computer of a user of the service. A series of processing constituting each service is performed, for example, under the control of the resource management device 30. For example, a storage device of the resource management device 30 stores addresses of a plurality of computational resources R on a service-by-service basis, and the resource management device 30 designates a transfer destination of data of processing results output by the computational resources R.

Processing by the computational resources R may be any type of arithmetic processing that is generally assumed such as process, aggregation, and merging of data to be processed, and examples of the processing include processing of reducing or enlarging the image size of image data, processing of detecting a specific object from image data, and processing of decrypting or encrypting image data.

The computing machines 10 and 20-1 to 20-N are different in processing that can be executed, but have similar configurations. Hereinafter, the configuration of the computing machine 10 will be described as a representative.

The computing machine 10 includes a processor 11, a main memory 12 of the processor 11, a nonvolatile storage device 13 that stores programs and various types of data, and a network interface card (NIC) 14 connected to the network NW. The computing machine 10 further includes an accelerator 15 that improves the function of the computing machine 10.

The processor 11 is constituted by a central processing unit (CPU) or the like, and controls the entire computing machine 10 by executing or using the programs and various types of data stored in the storage device 13. The main memory 12 is constituted a random access memory (RAM) or the like. The programs and various types of data are appropriately read to the main memory 12. The storage device 13 is constituted a solid state drive (SSD) or the like. The NIC 14 transmits and receives data to and from the network NW under the control of the processor 11.

The accelerator 15 is constituted by hardware such as a field-programmable gate array (FPGA). The processor 11 can dynamically, that is, regardless of the operation state of the computing machine 10, delete or add an arithmetic circuit as a computational resource R from or to a reconfigurable region of the accelerator 15. The operation state includes, for example, an in-processing state in which processing is being performed on data input from the computing machine 10 or a user or a client using the service, and an idle state in which no data has been input from the user or the client, that is, a state of being idle. The operation state further includes an initialization state that starts when the computing machine 10 is powered on and ends when the computing machine 10 becomes ready to provide processing (service).

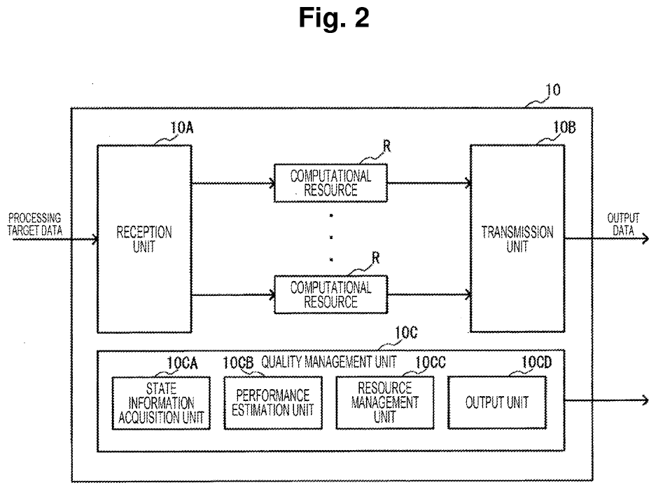

Besides the computational resources R, a reception unit 10A, a transmission unit 10B, and a quality management unit 10C are configured in the computing machine 10 as illustrated in FIG. 2. The reception unit 10A and the transmission unit 10B are constituted by the processor 11 that executes a program and the RAM 12. The quality management unit 10C is constituted by the processor 11 that executes a program. The reception unit 10A, the transmission unit 10B, and the quality management unit 10C are included in one housing of the computing machine 10.

The reception unit 10A temporarily holds processing target data input to the computing machine 10, and outputs the processing target data to at least one of the computational resources R set in advance, one for each piece of processing target data, in a subsequent stage. In a case where the computational resource R is performing computation, the reception unit 10A holds the processing target data until the computation ends. The computational resource R receives the processing target data output from the reception unit 10A, processes the processing target data, and outputs processing result (computation result) data to the transmission unit 10B. The transmission unit 10B temporarily accumulates the processing result data output from the computational resource R, and outputs the processing result data as output data to the outside of the computing machine 10.

The quality management unit 10C controls the quality of processing performed by the computing machine 10 using the computational resources R. The quality management unit 10C includes a state information acquisition unit 10CA, a performance estimation unit 10CB, a resource management unit 10CC, and an output unit 10CD.

The state information acquisition unit 10CA acquires state information indicating the state of the computing machine 10. The state of the computing machine 10 includes at least one of a state of input data that is processing target data input from the outside of the computing machine 10, a state of output data output to the outside of the computing machine 10, a processing content and a processing speed of the computational resources R already provided in the computing machine 10, or a load applied to the computing machine 10.

The state of input data or output data may include, for example, a speed of the input data or the output data, that is, an input data amount or an output data amount per unit time. This state may also include information for specifying whether the data is continuously input like stream data or the data is processed in an ad-hoc manner like data packets, which may cause an instantaneous increase or decrease in the amount of data (so-called bursty traffic). This state may also include a state whether the input data amount increases at a timing anticipated in advance for execution of batch processing, whether there is a time variation in the input/output data amount, or the like.

The processing content of the computational resources R already provided in the computing machine 10 may include, for example, any one of the computation amount required for computation by the computational resources R, the data amount of a computation parameter required for the computation, and the data amount of computation parameters held by memories of the computational resources R. The processing content may include information such as the amount of data after computation, that is, the data amount of output data after execution of a predetermined computation on input data.

The processing speed of the computational resources R may include at least one of a throughput, a latency, a time required to complete reading of the input data from the reception unit 10A, or a time required to start computation on the input data read from the reception unit 10A. The processing speed may include at least one of a time required to read a computation parameter required for computation of the input data from the memory, a time required to output data after computation to the transmission unit, or the like.

The load applied to the computing machine 10 may include at least one of the amount of data currently being input to the computing machine 10, the amount of data currently staying in the computing machine 10, or the number of users, the number of sessions of the network, or the number of clients included in the computing machine 10.

Each piece of the above information may not be input from the outside of the quality management unit 10C. The state information acquisition unit 10CA can collect the load applied to the computing machine 10 that changes from moment to moment by monitoring whether the computational resources R are performing computation, the buffer accumulation amount of the reception unit 10A, and the like.

On the basis of the state of the computing machine 10 indicated by acquired state information, the performance estimation unit 10CB estimates a change in processing performance of the computing machine 10 when at least one of dynamic addition or deletion of a computational resource R or an increase in data amount of the input data or output data occurs. The change in processing performance includes, for example, at least one of the processing performance after the change or the amount of change in processing performance. The processing performance is performance related to a processing time, and may be the processing time itself or the processing speed. For example, the storage device 13 stores the state of the computing machine 10 and a relational expression or table indicating a relationship between the change in processing performance and the content (e.g., circuit scale) of the computational resource R to be added or deleted or the amount of increase in data amount, and the performance estimation unit 10CB uses the relational expression or table to acquire the change in processing performance on the basis of the state of the computing machine 10 and the content of the computational resource R to be added or deleted or the amount of increase in data amount. Thus, the change in processing performance is estimated. The relationship between the above state and the change in processing performance is exemplified below. Therefore, the content of the relational expression or table, the information adopted as the state of the computing machine 10, and the information adopted as the change in processing performance are defined in consideration of the following examples.

In a case where a memory access band is shared by a plurality of computational resources R, adding a computational resource R that needs to read a computation parameter from the memory may result in a relative reduction in memory access band per computational resource R for the computational resources R already arranged and operated. The relative reduction in memory access band per computational resource R may result in an increase in time required to read the computation parameter and a decrease in time (latency) until computation of processing target data is completed and/or amount of data (throughput) that can be computed per unit time. Furthermore, for example, in a case where a plurality of computational resources R for performing the same computation has been provided and any one of the plurality of computational resources is deleted, parallel processing or the like is reduced accordingly, and this may result in a decrease in time (latency) until computation of processing target data is completed and/or amount of data (throughput) that can be computed per unit time.

When the input data amount (the input data amount of the processing target data) increases, the data amount in processing of allocating the processing target data from the reception unit 10A to the computational resources R increases, and this may result in an increase in time for temporarily buffering the data. The increase in buffering time may result in an increase in time (latency) until computation of processing target data is completed, and/or a decrease in the amount of data (throughput) that can be computed per unit time.

An increase in output data amount increases the possibility that outputs of the computational resources R coincide with each other when data after computation is output from each computational resource R to the transmission unit 10B. An increase in time in which the computational resources R are waiting for output, that is, an increase in buffering time, may result in an increase in time (latency) until computation of input data is completed, and/or a decrease in the amount of data (throughput) that can be computed per unit time.

The resource management unit 10CC determines whether to dynamically add or delete a computational resource R on the basis of the change in processing performance estimated by the performance estimation unit 10CB. For example, in a case where the amount of change in processing performance is equal to or less than a predetermined threshold, the resource management unit 10CC determines that the addition or deletion is possible. More specifically, the resource management unit 10CC determines that the addition or deletion is possible in a case where the amount of decrease in processing performance is equal to or less than a predetermined threshold, for example, in a case where the degree of prolongation of the processing time is equal to or less than a predetermined threshold, and the decrease in processing performance is small. The resource management unit 10CC may dynamically add or delete a computational resource R when it is determined that the addition or deletion is possible. Alternatively, information indicating that addition or deletion is possible may be transmitted to the resource management device 30 side. The resource management unit 10CC may determine whether the input data can be increased or deleted on the basis of the change in processing performance estimated by the performance estimation unit 10CB. In a case where the input data can be increased or deleted, the resource management device 30 may be notified accordingly.

The output unit 10CD may output the change in processing performance itself to the outside of the computing machine 10. The output information is output to the outside of the computing machine 10 via the NIC 14 or the like. In this case, for example, the resource management device 30 determines whether to add or delete a computational resource R and/or whether to increase the amount of data to be processed for the computing machine 10.

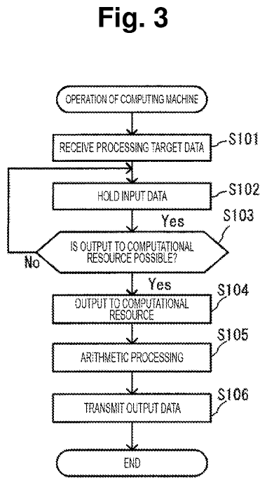

The reception unit 10A, the computational resources R, and the transmission unit 10B of the computing machine 10 perform processing in FIG. 3 on the processing target data. Specifically, the reception unit 10A first receives processing target data input from the outside of the computing machine 10, and temporarily holds the processing target data (steps S101 and S102). In a case where the computational resources R in the subsequent stage are performing computation and the reception unit 10A cannot output the processing target data, the data is held until it becomes possible to output the processing target data (steps S103 and S102). When it becomes possible to output the processing target data, the reception unit 10A outputs the processing target data to a computational resource R set in advance as an output destination for each piece of processing target data (step S104). Thereafter, the computational resource R performs arithmetic processing on the processing target data (step S105). At this time, a plurality of computational resources R may sequentially perform arithmetic processing on the processing data. The transmission unit 10B temporarily holds, as output data, the processing target data after the arithmetic processing output from the computational resource R, and outputs the output data to the outside of the computing machine 10.

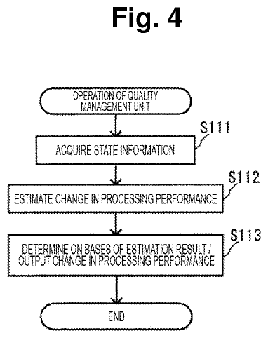

Upon receiving a request to add or delete a computational resource R or a notification of an increase in the input data from the resource management device 30, the quality management unit 10C executes processing illustrated in FIG. 4.

In the processing in FIG. 4, first, the state information acquisition unit 10CA of the quality management unit 10C acquires state information indicating the state of the computing machine 10 (step S111). Then, on the basis of the state of the computing machine 10 indicated by the acquired state information, the performance estimation unit 10CB estimates a change in processing performance of the computing machine 10 when at least one of dynamic addition or deletion of a computational resource R or an increase in data amount of the input data or output data occurs (step S112). Then, on the basis of the change in processing performance estimated by the performance estimation unit 10CB, the resource management unit 10CC may determine, for example, whether a computational resource R can be added or deleted (step S113). If addition or deletion is possible, a computational resource R may be added or deleted. In addition to or instead of this, the output unit 10CD may output the change in processing performance itself to the outside of the computing machine 10 (step S113).

While the processing is started when, for example, the computing machine 10 receives a request to add or delete a computational resource R in the above example, the quality management unit 10C may monitor an increase in the input/output data amount and start the processing when the increase becomes significant and satisfies a predetermined criterion. Alternatively, processing similar to the above processing may be executed when a notification of data reduction is received.

In the present embodiment, a change in processing performance of the computing machine 10 when at least one of dynamic addition or deletion of a computational resource R or an increase in data amount of the input data or output data occurs is estimated on the basis of the state of the computing machine 10 indicated by state information. Then, it is possible to determine, for example, whether at least one of addition or deletion of a computational resource R or an increase in data is possible using the estimated change, and this allows for appropriately managing the hardware configuration of a plurality of computational resources R that performs at least a part of a service for processing of processing target data. For example, in a case where it is estimated that adding a computational resource R to the computing machine 10 would greatly decrease the processing performance, addition of a computational resource R is inhibited, so that occurrence of a processing delay can be inhibited. In a case where it is estimated that deleting any one of a plurality of computational resources R, the plurality of computational resources R being for performing the same computation and configured in the computing machine 10, would not significantly decrease the processing performance, it is possible to delete that computational resource R to reduce power consumption.

In addition, since the estimation is executed in the computing machine 10, the time required from acquisition of state information to determination is shortened as compared with a case where the estimation is executed outside the computing machine 10, and thus, the estimation result is provided in more real time. Furthermore, since the amount of data for outputting the state information for estimation to the outside is unnecessary, more detailed information can be reflected in the estimation result.

### Second Embodiment

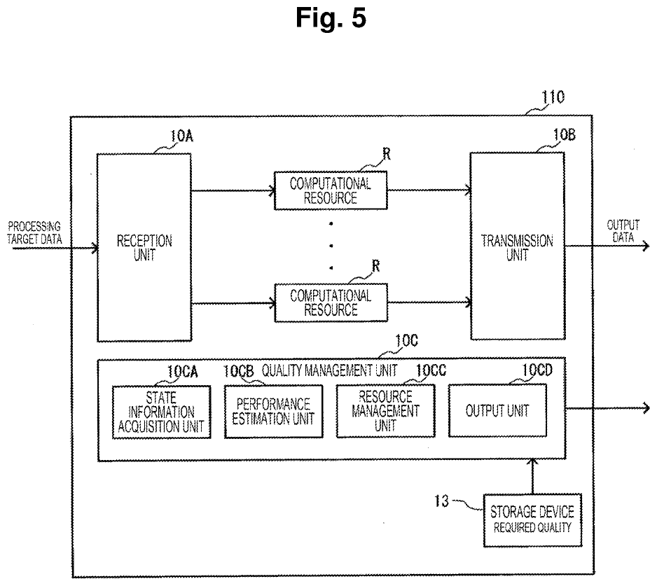

FIG. 5 illustrates a configuration of a computing machine 110 according to a second embodiment. The computing machine 110 has substantially the same configuration as the computing machine 10. However, in a case where a change in processing performance estimated by a performance estimation unit 10CB falls within a required performance required of the computing machine 110, a resource management unit 10CC outputs, to the outside of the computing machine 110, information indicating that at least one of addition or deletion of a computational resource or an increase in data amount of input data or output data is possible. The required performance is stored in a storage device 13 and used. The required performance is prepared for each computational resource R, for example. When a change in processing performance is estimated for addition or deletion of a computational resource R, the required performance corresponding to the computational resource R to be added or deleted is used. When a change in processing performance is estimated for an increase in data amount of the input data or output data, the required performance corresponding to the current computational resources R of the computing machine 110 is used. For example, the required performance may be a required value related to a time from start to completion of processing by the computational resources R, a required value related to a processing throughput (the amount of data input/output per unit time) of the computational resources R, or the like. The request value may vary depending on the service, and may have a plurality of request values in accordance with the quality of the service. An increase in data amount of input data or output data includes acceptance of new input data and addition of a new user.

Acquisition of the state information or the like may be started in response to detection of an increase in input data amount, or may be started in response to a notification or advance notice regarding an increase in input data amount from a resource management device 30. In a case where the change in processing performance estimated by the performance estimation unit 10CB does not fall within the required performance required of the computing machine 110, the resource management unit 10CC may notify the resource management device 30 of a determination result instructing offloading to another computing machine 20 capable of providing a similar computational resource R.

In this embodiment, determination by the resource management unit 10CC is performed in the computing machine 110, and the time required to acquire a determination result is shortened and the amount of data output to the outside is reduced as compared with a case where the determination is performed outside. In addition, information that at least one of addition or deletion of a computational resource or an increase in data amount of the input data or output data is possible is output to the outside of the computing machine 110, and thus, the external resource management device 30 can easily determine whether to add or delete a computational resource R.

### Third Embodiment

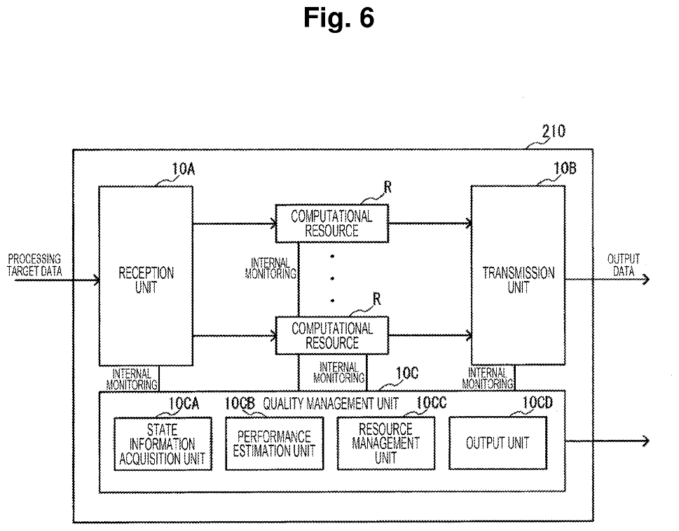

FIG. 6 illustrates a configuration of a computing machine 210 according to a third embodiment. The computing machine 210 has substantially the same configuration as the computing machine 10. However, a resource management unit 10CC monitors the internal state of the computing machine 210, more specifically, the internal states of a reception unit 10A, computational resources R, and a transmission unit 10B, and requests a resource management device 30, which is outside, to add or delete a computational resource R in accordance with the internal state being monitored. For example, in a case where a processing delay occurs, addition of a computational resource R for parallel processing is requested in order to solve the processing delay. The resource management unit 10CC monitors the internal state of the computing machine 210, and notifies the resource management device 30, which is outside, of an allowable data amount of processing target data input to the computing machine 210 in accordance with the internal state being monitored. The allowable amount includes the amount of new input data accepted and the number of new users added. The resource management unit 10CC autonomously monitors the internal state of the computing machine 210, more specifically, the internal states of the reception unit 10A, the computational resources R, and the transmission unit 10B.

The resource management unit 10CC monitors the flow of data per unit time at a plurality of monitoring points. In a case where the flow exceeds a predetermined threshold as a result of the monitoring, the resource management unit 10CC requests the resource management device 30 to add a computational resource R for parallel processing, for example. Note that a combination of two or more pieces of information may be monitored. In a case where two or more pieces of information are combined, the processing becomes complicated, and thus the two or more pieces of information may be monitored individually.

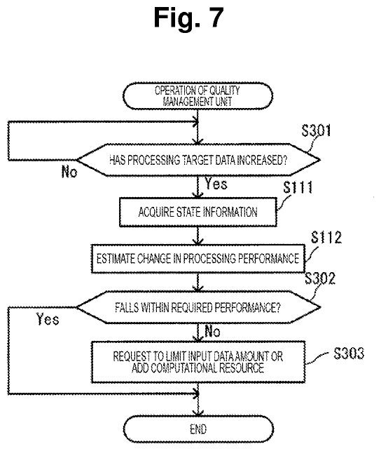

A quality management unit 10C executes processing illustrated in FIG. 7. Specifically, the resource management unit 10CC of the quality management unit 10C monitors the internal states of the reception unit 10A, the computational resources R, and the transmission unit 10B in the computing machine 210, and detects, for example, an increase in the input amount of processing target data in the reception unit 10A (step S301). In a case where the increase is detected, steps S111 and S112 similar to those in the first embodiment are executed. Thus, state information is acquired and a change in processing performance is estimated. Thereafter, the resource management unit 10CC determines whether the estimation result falls within a predetermined required performance (the changed processing performance satisfies the required performance) (step S302), and if the estimation result falls within the predetermined required performance, this processing ends. If not, the resource management device 30 is requested to limit the amount of processing target data to be input or to add a computational resource R (step S303). Note that deletion may be requested as necessary. In response to the request, the resource management device 30 limits the amount of processing target data and/or instructs the computing machine 210 to add or delete a computational resource R.

According to the present embodiment, various requests are made in accordance with the internal state of the computing machine 10, and the computational resources R are appropriately managed. In addition, the input data amount is appropriately managed. The computing machine 10 autonomously monitors the internal states of the reception unit 10A, the computational resources R, and the transmission unit 10B, and this allows the internal states to be acquired at a higher speed than in a case where the internal states are monitored by an external system or device, and this has an effect of shortening the time from when the internal states are acquired to when an estimation result is calculated. While using a computational resource R that causes an increase in data size makes it difficult to monitor the internal states and the internal load from the outside, the computing machine 10 autonomously monitoring the internal states of the reception unit 10A, the computational resources R, and the transmission unit 10B has an effect of acquiring an estimation result with high accuracy also for a computational resource R that causes an increase in data size. In addition, the computing machine 10 autonomously monitors the internal states, and this allows an estimation result or a determination result to be promptly output when an external system or device requests the computing machine 10 to add or delete a computational resource R.

### Scope of Embodiments of the Present Invention

The present invention is not limited to the above-described embodiments and modification examples. For example, the present invention includes various modifications to the above embodiments and modification examples that can be understood by those skilled in the art within the scope of the technical idea of the present invention. The configurations described in the above embodiments and modification examples can be appropriately combined without inconsistency. It is also possible to delete any of the above-described components. The program may be stored not in a nonvolatile storage device 13, but in a non-transitory computer-readable storage medium.

### REFERENCE SIGNS LIST

10 Computing machine
10A Reception unit
10B Transmission unit
10C Quality management unit
10CA State information acquisition unit
10CB Performance estimation unit
10CC Resource management unit
10CD Output unit
11 Processor
12 Main memory
13 Storage device
15 Accelerator
20-1 to 20-N Computing machine
30 Resource management device
110 Computing machine
210 Computing machine
R Computational resource

1-8. (canceled)

9. A computing machine, comprising:
a memory storage configured to store instructions; and
one or more processors in communication with the memory storage, wherein the one or more processors execute the instructions to:
acquire state information indicating a state of the computing machine; and
estimate, based on the state of the computing machine, a change in processing performance of the computing machine when dynamic addition or deletion of a computational resource from outside of the computing machine, an increase in data amount of input data input from the outside of the computing machine, or an increase in data amount of output data output to the outside of the computing machine occurs.

10. The computing machine according to claim 9, wherein:
the state of the computing machine includes a state of the input data, a state of the output data, a processing content and a processing speed of a computational resource currently provided in the computing machine, or a load applied to the computing machine.

11. The computing machine according to claim 9, wherein the instructions include further instructions to determine whether to dynamically add or delete the computational resource from the outside of the computing machine based on the estimated change in processing performance.

12. The computing machine according to claim 9, further comprising:
an output configured to output the estimated change in processing performance to the outside of the computing machine.

13. The computing machine according to claim 9, wherein the instructions include further instructions to:
in a case where the estimated change in processing performance falls within a required performance required of the computing machine, output, to the outside of the computing machine, information indicating that addition or deletion of the computational resource or an increase in the data amount of the input data or the output data is possible.

14. The computing machine according to claim 9, wherein the instructions include further instructions to:
monitor an internal state of the computing machine, and request an external device that is the outside of the computing machine to add or delete the computational resource in accordance with the internal state being monitored.

15. The computing machine according to claim 9, wherein the instructions include further instructions to:
monitor an internal state of the computing machine; and
notify an external device that is the outside of the computing machine of an allowable data amount of processing target data input to the computing machine in accordance with the internal state being monitored.

16. A non-transitory storage device configured to store computer instructions that when executed by one or more processors of a computing machine, cause the one or more processors to perform the steps of:
acquiring state information indicating a state of the computing machine; and
estimating, based on the state of the computing machine, a change in processing performance of the computing machine when dynamic addition or deletion of a computational resource from outside of the computing machine, an increase in data amount of input data input from the outside of the computing machine, or an increase in data amount of output data output to the outside of the computing machine occurs.

17. The non-transitory storage device according to claim 16, wherein:
the state of the computing machine includes a state of the input data, a state of the output data, a processing content and a processing speed of a computational resource currently provided in the computing machine, or a load applied to the computing machine.

18. The non-transitory storage device according to claim 16, wherein the instructions when executed by the one or more processors of a computing device, cause the one or more processors to further perform the steps of:
determining whether to dynamically add or delete the computational resource from the outside of the computing machine based on the estimated change in processing performance.

19. The non-transitory storage device according to claim 16, wherein the instructions when executed by the one or more processors of a computing device, cause the one or more processors to further perform the steps of:
outputting the estimated change in processing performance to the outside of the computing machine.

20. The non-transitory storage device according to claim 16, wherein the instructions when executed by the one or more processors of a computing device, cause the one or more processors to further perform the steps of:
in a case where the estimated change in processing performance falls within a required performance required of the computing machine, output, to the outside of the computing machine, information indicating that addition or deletion of the computational resource or an increase in the data amount of the input data or the output data is possible.

21. The non-transitory storage device according to claim 16, wherein the instructions when executed by the one or more processors of a computing device, cause the one or more processors to further perform the steps of:
monitoring an internal state of the computing machine, and request an external device that is the outside of the computing machine to add or delete the computational resource in accordance with the internal state being monitored.

22. The non-transitory storage device according to claim 16, wherein the instructions when executed by the one or more processors of a computing device, cause the one or more processors to further perform the steps of:
monitor an internal state of the computing machine; and
notify an external device that is the outside of the computing machine of an allowable data amount of processing target data input to the computing machine in accordance with the internal state being monitored.

23. A method, comprising:
acquiring, by a computing machine, state information indicating a state of the computing machine; and
estimating, by the computing machine, based on the state of the computing machine, a change in processing performance of the computing machine when dynamic addition or deletion of a computational resource from outside of the computing machine, an increase in data amount of input data input from the outside of the computing machine, or an increase in data amount of output data output to the outside of the computing machine occurs.

24. The method according to claim 23, wherein:
the state of the computing machine includes a state of the input data, a state of the output data, a processing content and a processing speed of a computational resource currently provided in the computing machine, or a load applied to the computing machine.

25. The method according to claim 23, further comprising:
determining whether to dynamically add or delete the computational resource from the outside of the computing machine based on the estimated change in processing performance.

26. The method according to claim 23, further comprising:
outputting the estimated change in processing performance to the outside of the computing machine.

27. The method according to claim 23, further comprising:
in a case where the estimated change in processing performance falls within a required performance required of the computing machine, output, to the outside of the computing machine, information indicating that addition or deletion of the computational resource or an increase in the data amount of the input data or the output data is possible.

28. The method according to claim 23, further comprising:
monitoring an internal state of the computing machine, and request an external device that is the outside of the computing machine to add or delete the computational resource in accordance with the internal state being monitored; and
notifying the external device of an allowable data amount of processing target data input to the computing machine in accordance with the internal state being monitored.
